(19) United States
(12) Patent Application Publication
(10) Pub. No.: US 2016/0040753 A1
(43) Pub. Date: Feb. 11, 2016

(54) LINK PLATE

(71) Applicant: WEN-PIN WANG, TAINAN CITY (TW)

(72) Inventor: WEN-PIN WANG, TAINAN CITY (TW)

(21) Appl. No.: 14/453,719

(22) Filed: Aug. 7, 2014

(51) Int. Cl. F16G 13/07

(52) U.S. Cl. CPC F16G 13/07

(57) ABSTRACT

A link plate, wherein a combining portion is correspondingly configured on each of the two ends of a link plate body, wherein an axle hole is configured on each combining portion and a middle portion is configured between the two combining portions, wherein an arc-shaped connection surface is configured at the junction between the middle portion and a corresponding one of the two combining portions, wherein each connection surface has an inner edge and an outer edge forming borders with the middle portion and a corresponding combining portion, respectively, and being configured as equidistance double arcs, and wherein at least one protrusion protruding from the middle portion is configured between the two connection surfaces.

### FIELD OF THE INVENTION

The invention relates to a link plate, and more particularly, to a link plate with protrusion design to facilitate the rapid guiding for chainring teeth of chainring for meshing, shifting, and stable transmission.

### BACKGROUND OF THE INVENTION

The distances between the two oppositely assembled outer link plates of conventional bicycles are usually increased to accommodate the shifting under higher speeds so that the chain may accurately mesh with the chainring and each chainring tooth may properly enter the two oppositely assembled outer link plates, and the chances of the chainring teeth not properly entering due to the swinging of the chain or the vibration of the bicycle may be reduced. As shown in FIG. 13 and FIG. 14, conventional chains comprises outer link plates (A) configured in pairs and inner link plates (B) configured in pairs that are arranged alternatingly and pivotally connected by link pins (C), wherein an arc-shaped combining portion (A1) is correspondingly configured on each of the two ends of each outer link plate (A). Moreover, a middle portion (A2) expanded from an inner surface towards an outer surface is configured between the two combining portions (A1), and wherein the junction between the middle portion (A2) and a corresponding combining portion (A1) is configured with a connection surface (A3) as a straight line, so that the guiding space formed between the two outer link plates (A) of the chain may be larger to facilitate the shifting of the chain under higher speeds.

However, in practice, it is discovered that although the guiding space may be larger in the above chain structure to accommodate the shifting under higher speeds, the following shortcomings exist: 1) the expanded middle portion (A2) formed by stamping along with the connection surface (A3) as a straight line easily concentrate stress at the bending portion between the expanded middle portion (A2) of the outer link plate (A) and the connection surface (A3), which may place the outer link plate (A) under risk of fracturing from the bending portion; 2) the aligning distance (E1) between the middle portions (A2) of the outer link plates (A) is too large and causes the chain to swing leftwards or rightwards, which may result in vibration, noise, or dislocation when the chain meshes with the chainring due to the tolerance range of the swinging angle of the chain during transmission being too large; and 3) since the connection surfaces (A3) at the junctions between the middle portion (A2) and the two combining portions (A1) are straight lines and chainring teeth (D1) of common chainring (D) have arc shapes (as in FIG. 15), the straight-line connection surface (A3) hinders the meshing of the chainring teeth (D1) of chainring (D) and impedes the motion of the chain which may result in chain dislocation under severe situations.

Therefore, the above outer link plate (A) of conventional chains do not perform well when shifting.

### SUMMARY OF THE INVENTION

In view of the above shortcomings of conventional link plates, the invention provides a link plate, comprising a link plate body. Two ends of the link plate body each are configured with a combining portion, wherein the two combining portions are opposite to each other and each have an axle hole. A middle portion is configured between the two combining portions. The junction between the middle portion and a corresponding combining portion is configured with an arc-shaped connection surface, and wherein at least one protrusion protruding from the middle portion is configured between the two connection surfaces.

Preferably, each connection surface has an inner edge and an outer edge, which form borders with the middle portion and a corresponding combining portion, respectively, and wherein the inner edge and the outer edge are arc-shaped.

Preferably, the inner and outer edges of each connection surface are configured as equidistance double arcs.

Preferably, each connection surface further has two guiding surfaces extending therefrom, and wherein the two guiding surfaces of each connection surface expand at two side edges of the link plate body, respectively.

Preferably, two side edges of the middle portion each are configured with an inclined entrance portion, wherein the two entrance portions of the middle portion are opposite to each other and each extend between two of said guiding surfaces.

Preferably, the middle portion has a sunken inner surface and a raised outer surface, and wherein the middle portion is thin relative to other portions of the link plate body.

Preferably, the middle portion has a sunken inner surface and a flat outer surface, and wherein the middle portion is thin relative to other portions of the link plate body.

Preferably, the link plate body is an outer link plate or an inner link plate.

Preferably, each connection surface is an inclined surface or a flat surface.

Preferably, each connection surface inclines from a corresponding combining portion towards the middle portion.

The invention may have the following advantages: (1) by configuring the middle portion to be indented by expanding from the inner surface of the link plate body towards the outer surface of the link plate body and thinned, the guiding distance between two correspondingly assembled link plate bodies may be increased so that the chainring teeth of chainring may be rapidly guided to mesh with the chain during shifting; (2) the relatively smaller aligning distance between correspondingly arranged protrusions of the two link plate bodies may keep the top portions of chainring teeth of chainring limited within so that the chain does not swing, vibrate, generate noise, or dislocate during transmission; (3) by using a connection surface designed with double arcs, a larger expanding guiding surface may be provided; the double-arc profile of the inner edge and outer edge of the connection surface may conform with the chainring teeth of chainring similarly configured to have a corresponding arc profile and rapidly guide the chainring teeth along the double-arc-shaped connection surface and the expanding guiding surface to enter the entrance portion and mesh in the middle portion to facilitate shifting; (4) the connection surface designed with double arcs may effectively distribute stress so that the chain will not fracture during motion due to concentrated stress and danger may be avoided; and (5) the connection surface designed with double arcs may also render the link plate body to completely shield the chainring to enhance stability and smoothness during rides and avoid vibration and swinging.

### BRIEF DESCRIPTION OF THE DRAWINGS

The invention as well as a preferred mode of use and the advantages thereof will be best understood by referring to the following detailed description of some illustrative embodiments in conjunction with the accompanying drawings, in which:

FIG. 1 is a perspective view of an embodiment of the invention;

FIG. 2 is a top view of an embodiment of the invention;

FIG. 3 is a perspective view of an assembled chain using an embodiment of the invention;

FIG. 4 is a cross-sectional view taken along the line IV-IV in FIG. 3;

FIG. 5 is a schematic view showing how the chain meshes with a chainring in accordance with an embodiment of the invention;

FIG. 6 is a cross-sectional view showing how a chainring tooth of the chainring obliquely enters the guiding space between the two link plate bodies in accordance with an embodiment of the invention;

FIG. 7 is a cross-sectional view taken along the line VII-VII in FIG. 5, where the chainring tooth of the chainring is limited within the aligning space between two protrusions in accordance with an embodiment of the invention;

FIG. 8 is a perspective view of a first link plate body in accordance with another embodiment of the invention;

FIG. 9 is a perspective view from the back of a second link plate body in accordance with another embodiment of the invention;

FIG. 10 is a perspective view of an assembled chain using another embodiment of the invention;

FIG. 11 is a perspective view of a first link plate body in accordance with still another embodiment of the invention;

FIG. 12 is a perspective view of a second link plate body in accordance with still another embodiment of the invention;

FIG. 13 is a perspective view of a conventional outer link plate;

FIG. 14 is a perspective view of a conventional chain; and

FIG. 15 is a schematic view of a conventional chain meshing with a chainring.

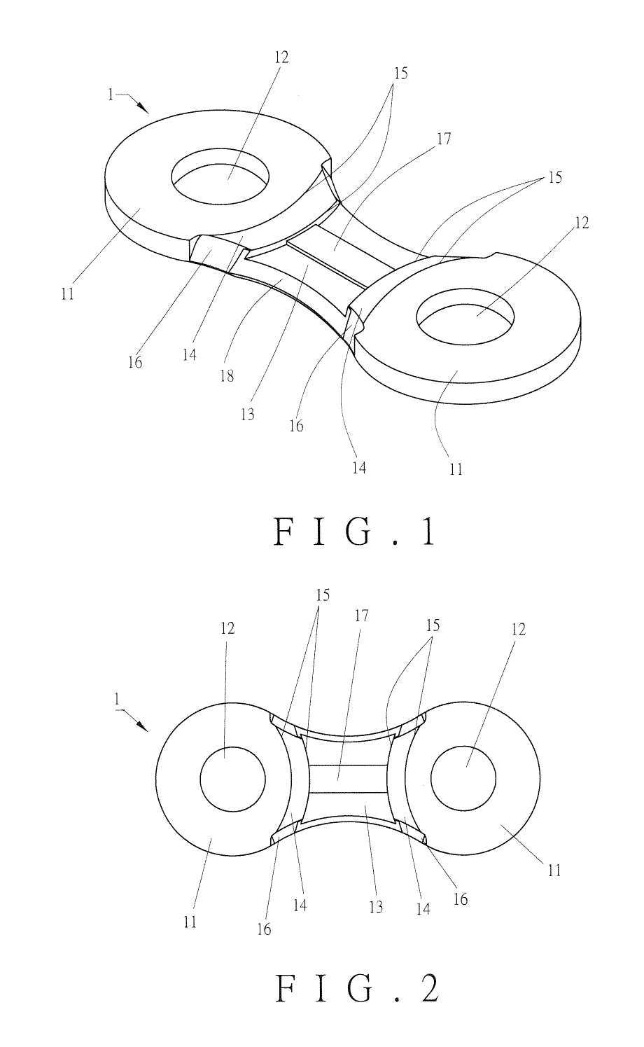

### DETAILED DESCRIPTION OF THE INVENTION

FIG. 1 shows a link plate body (1) according to an embodiment of the invention, wherein two ends of the link plate body (1) each are configured with an arc-shaped combining portion (11). The two combining portions (11) are opposite to each other and each have a penetrating axle hole (12). Moreover, a middle portion (13) is configured between the two combining portions (11), wherein the middle portion (13) is indented by expanding from the inner surface of the link plate body (1) towards the outer surface of the link plate body (1) and thinned. Thus, in this embodiment, the middle portion (13) has a sunken inner surface and a raised outer surface and is thin relative to other portions of the link plate body (1). The junction between the middle portion (13) and a corresponding combining portion (11) is configured with an arc-shaped connection surface (14) that may be inclined or flat. In this embodiment, the two connection surfaces (14) are inclined, and preferably, each connection surface (14) inclines from a corresponding combining portion (11) towards the middle portion (13). Each connection surface (14) has an inner edge and an outer edge forming the borders with the middle portion (13) and a corresponding combining portion (11), respectively. The inner edge and the outer edge of each connection surface (14) form two arcs (15) and, preferably, are configured as equidistance double arcs. Each connection surface (14) further has two guiding surfaces (16), which extend from the connection surface (14) and respectively expand outward at two opposite side edges of the link plate body (1), wherein at least one protrusion (17) that protrudes from the middle portion (13) is configured between the two connection surfaces (14). Furthermore, two side edges of the middle portion (13) each are configured with an inclined entrance portion (18), wherein the two entrance portions (18) are opposite to each other and each extend between two of the guiding surfaces (16).

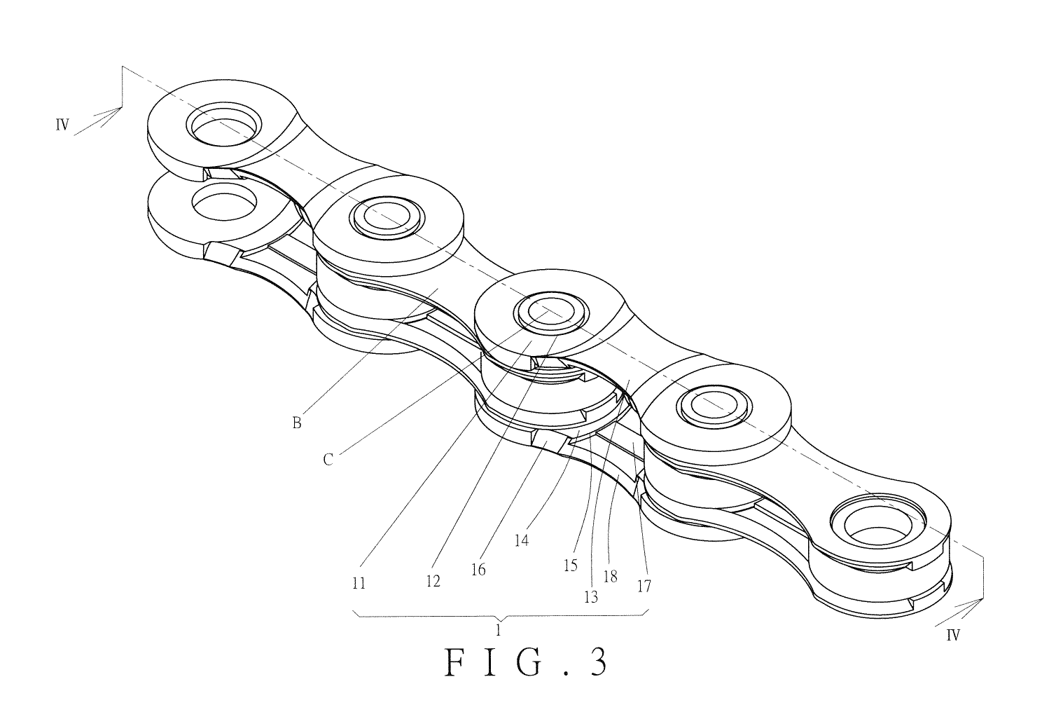

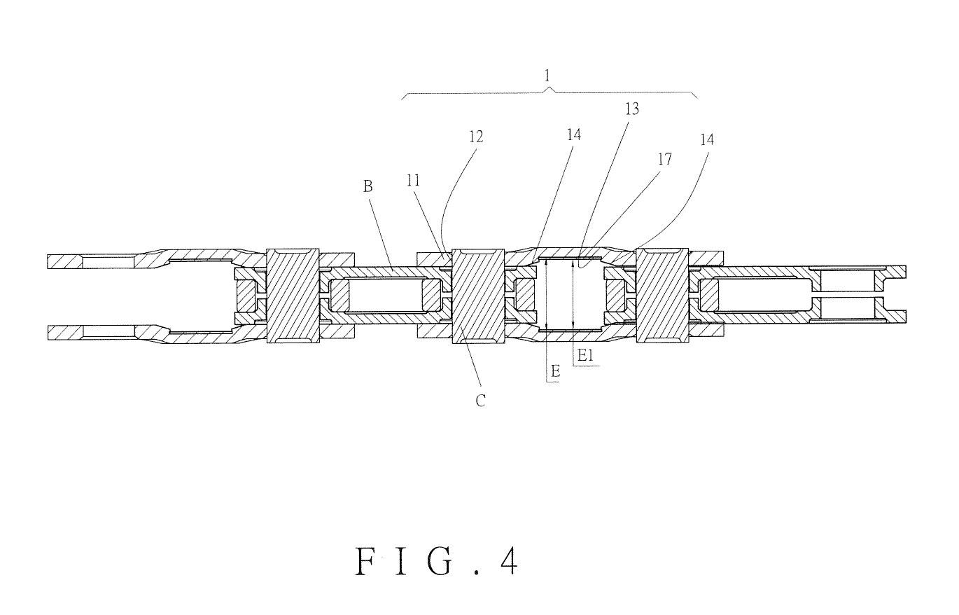

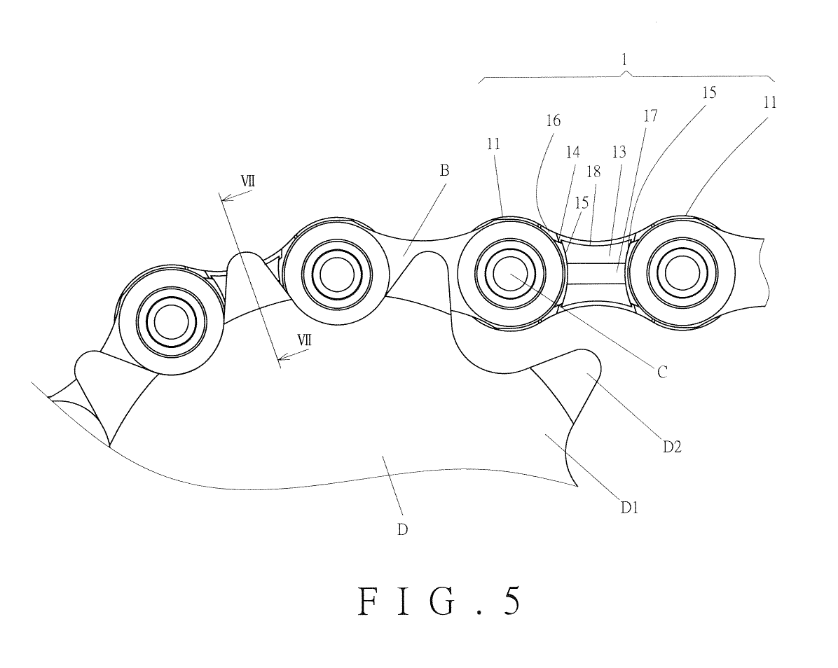

When assembled, as shown in FIG. 3, the link plate body (1) in this embodiment is configured as an outer link plate arranged with an inner link plate (B), wherein the link plate body (1) and the inner link plate (B) are correspondingly configured and pivotally connected to each other by means of a link pin (C). Specifically, multiple pairs of link plate bodies (1) and multiple pairs of inner link plates (B) are arranged alternatingly and then connected to each other by means of link pins (C) to form a chain for chainring teeth (Dl) of chainring (D) to mesh for transmission and shifting (as in FIG. 5). Preferably, each pair of inner link plates (B) is partially sandwiched between two oppositely assembled link plate bodies (1), and a guiding space formed between the middle portions (13) of two oppositely assembled link plate bodies (1) has a width defined as a guiding distance (E), while an aligning space formed between the protrusions (17) of two oppositely assembled link plate bodies (1) has a width defined as an aligning distance (E1), as shown in FIG. 4. It is noted that the guiding distance (E) in the invention is increased due to the fact that the middle portion (13) of each link plate body (1) is thinned and has a sunken inner surface.

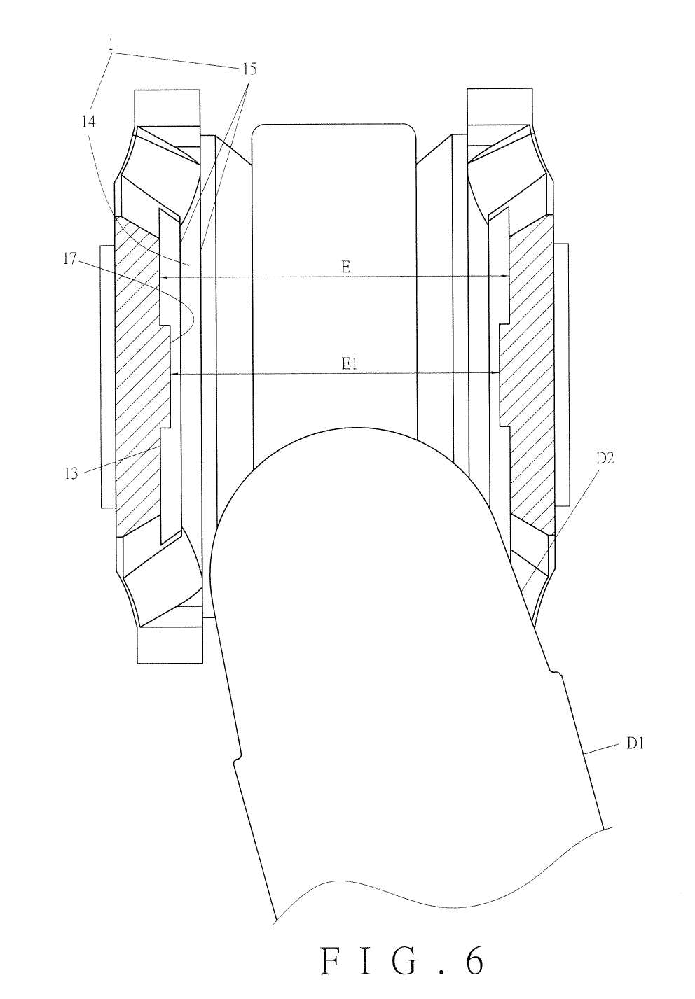

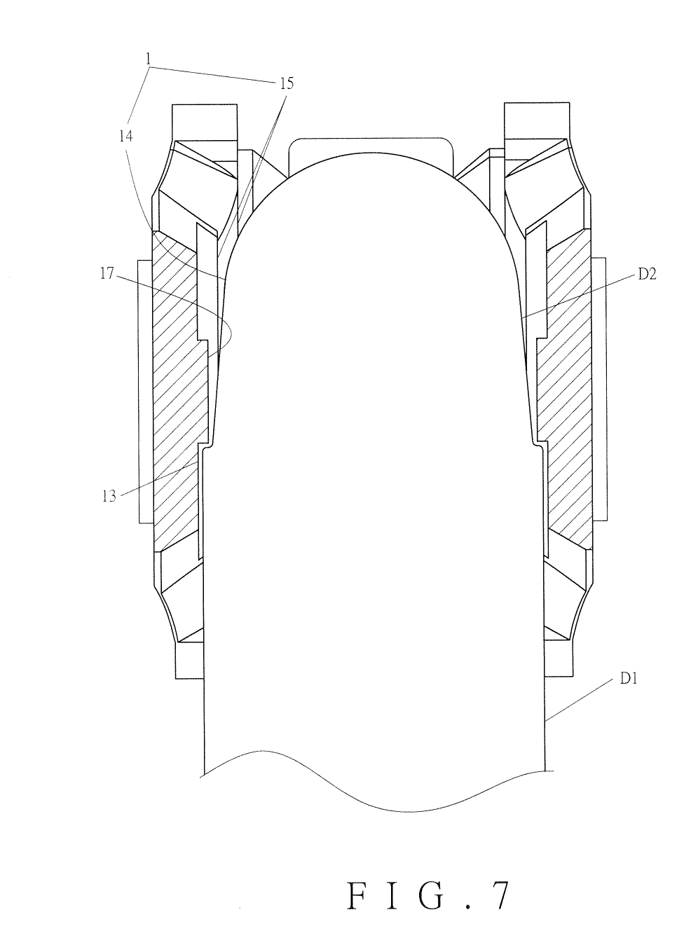

As shown in FIG. 4 and FIG. 5, since the inner and outer edges of each connection surface (14) are configured as double arcs, lager spaces may be provided for configuring the two guiding portions (16), respectively expanding outward at two opposite side edges of the link plate body (1), of each connection surface (14); in addition, the double-arc profile of each connection surface (14) may conform with the chainring teeth (D1) of chainring (D) configured to have a similar double-arc profile. Therefore, when the chain is shifted between chainrings (D) during rides, the chainring teeth (D1) may be rapidly guided along the double-arc-shaped connection surfaces (14) and the guiding surfaces (16) extending from which to enter the entrance portion (18) and then mesh in the guiding space formed between the middle portions (13) of two oppositely assembled link plate bodies (1). More specifically, when the top portion (D2) of tapered chainring tooth (D1) is obliquely enter the guiding space (as in FIG. 6), the chainring tooth (D1) of chainring (D) may be rapidly guided to mesh with the chain by means of the relatively larger guiding distance (E), and then the chain may be rapidly aligned by means of the relatively smaller aligning distance (E1). Consequently, the top portion (D2) of chainring tooth (D1) of chainring (D) is limited within the aligning space formed between the protrusions (17) of two oppositely assembled link plate bodies (1) (as in FIG. 7) so that the chain does not swing during transmission, achieving rapid shifting, vibration reduction, noise reduction, and prevention of chain dislocation.

Furthermore, since each connection surface (14) is double-arc-shaped, the shortcoming of concentrated stress does not occur and the chain may effectively distribute stress during motion so that the chain will not easily fracture at the bending portion as does the conventional link plate with straight-shaped connection surfaces and thus the risk of fracturing is reduced. Besides rapidly guiding the chainring teeth (D1) of chainring (D) along the double-arc-shaped connection surfaces (14), the double-arc-shaped connection surfaces (14) may also render the link plate bodies (1) to completely shield the chainring teeth (D1) to enhance stability and smoothness during rides and avoid vibration and swinging during motion.

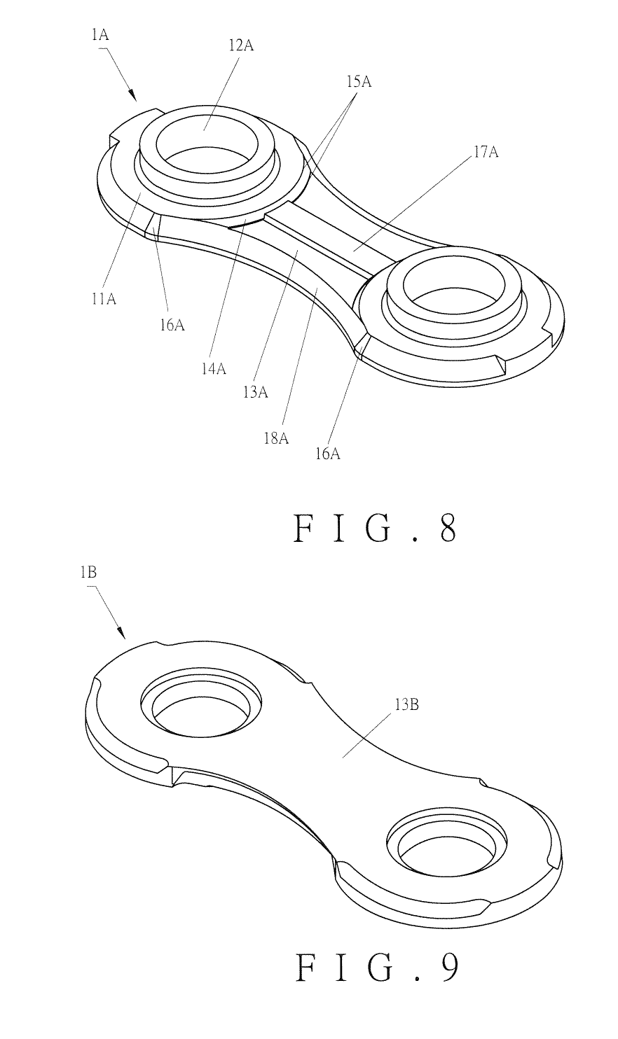

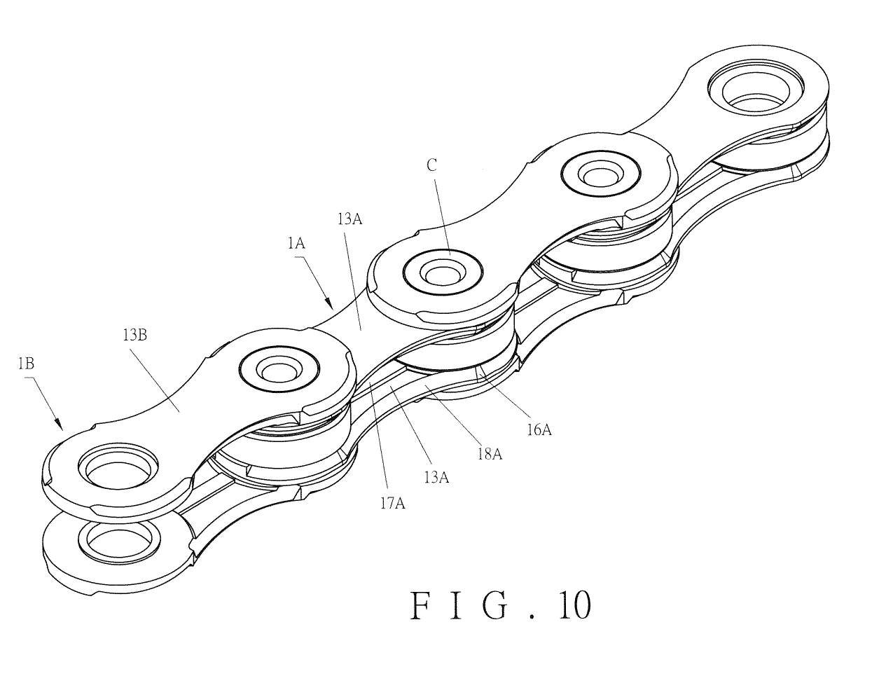

FIG. 8 and FIG. 9 show a first link plate body (1A) and a second link plate body (1B), respectively, in accordance with another embodiment of the invention. The first link plate body (1A) is configured as an inner link plate, while the second link plate body (1B) is configured as an outer link plate.

As shown in FIG. 8, two ends of the first link plate body (1A) each are configured with an arc-shaped first combining portion (11A). The two arc-shaped first combining portions (11A) are opposite to each other and each have a penetrating axle hole (12A). Moreover, a first middle portion (13A) is configured between the two first combining portions (11A), wherein the first middle portion (13A) is indented by expanding from an inner surface of the first link plate body (1A) towards an outer surface of the first link plate body (1A) and thinned. Thus, in this embodiment, the first middle portion (13A) has a sunken inner surface and a flat outer surface and is thin relative to other portions of the first link plate body (1A). The junction between the first middle portion (13A) and a corresponding first combining portion (11A) is configured with an arc-shaped first connection surface (14A), wherein each first connection surface (14A) inclines from a corresponding first combining portion (11A) towards the first middle portion (13A). Each first connection surface (14A) has an inner edge and an outer edge forming the borders with the first middle portion (13A) and a corresponding first combining portion (11A), respectively. The inner edge and the outer edge of each first connection surface (14A) form two first arcs (15A) and, preferably, are configured as equidistance double arcs. Each first connection surface (14A) further has two first guiding surfaces (16A), which extend from the first connection surface (14A) and respectively expand outward at two opposite side edges of the first link plate body (1A), wherein a first protrusion (17A) protruding from the first middle portion (13A) is configured between the two first connection surfaces (14A). Furthermore, two side edges of the first middle portion (13A) each are configured with an inclined first entrance portion (18A), wherein the two first entrance portions (18A) are opposite to each other and each extend between two of the first guiding surfaces (16A).

As shown in FIG. 9, the second link plate body (1B) comprises a second middle portion (13B). The second middle portion (13B) is indented by expanding from the inner surface of the second link plate body (1B) towards the outer surface of the second link plate body (1B) and thinned. Thus, in this embodiment, the second middle portion (13B) has a sunken inner surface and a flat outer surface and is thin relative to other portions of the second link plate body (1B).

When assembled, as shown in FIG. 10, the first link plate body (1A) is arranged with the second link plate body (1B) in this embodiment, wherein the first link plate body (1A) and the second link plate body (1B) are correspondingly configured and pivotally connected to each other by means of a link pin (C). Specifically, multiple pairs of first link plate bodies (1A) and multiple pairs of second link plate bodies (1B) are arranged alternatingly and then connected to each other by means of link pins (C) to form a chain for chainring teeth of chainring to mesh for transmission and shifting.

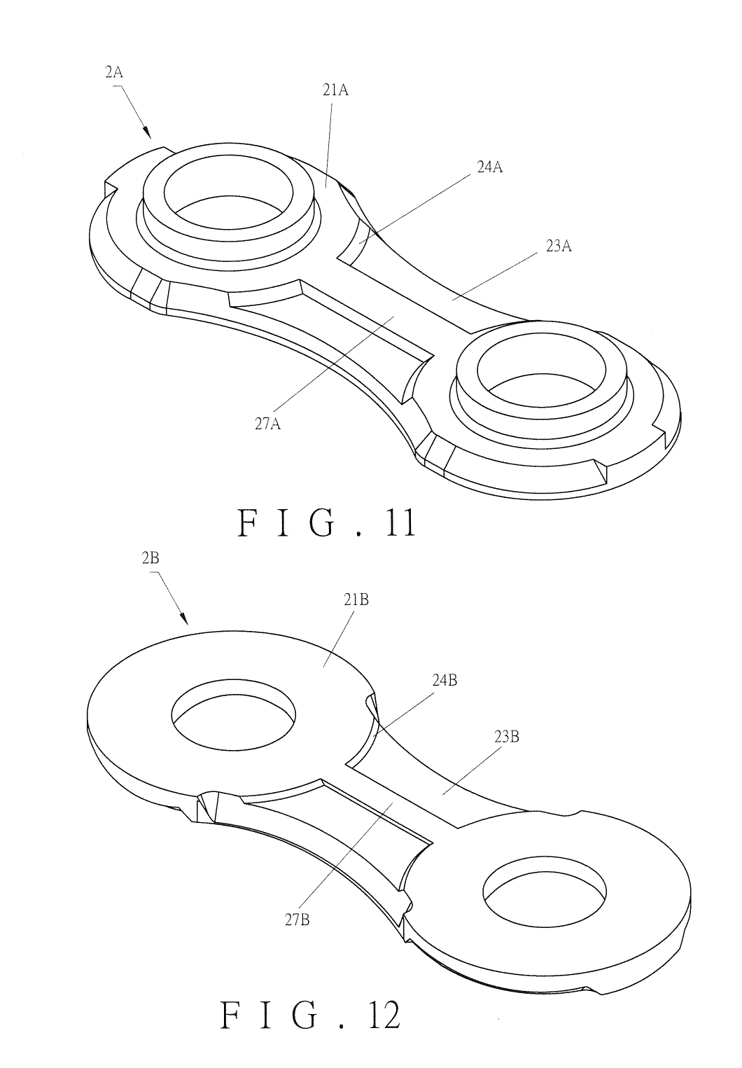

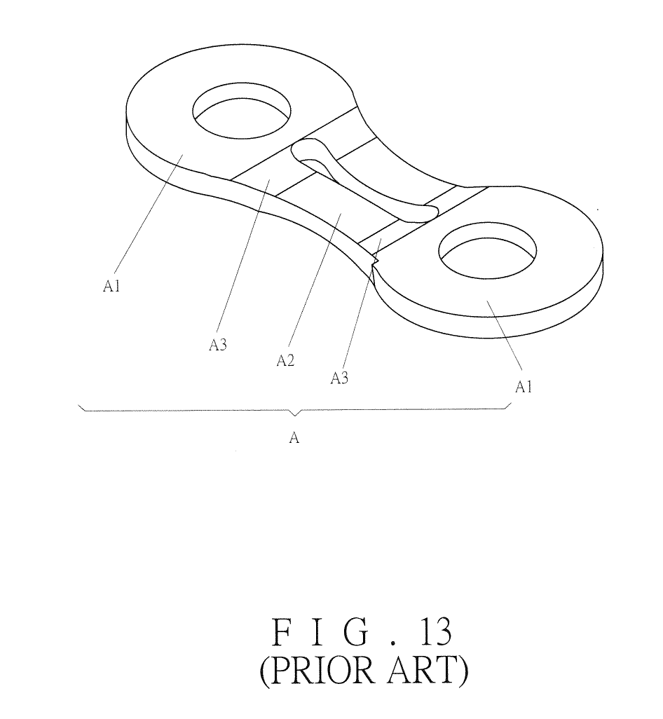

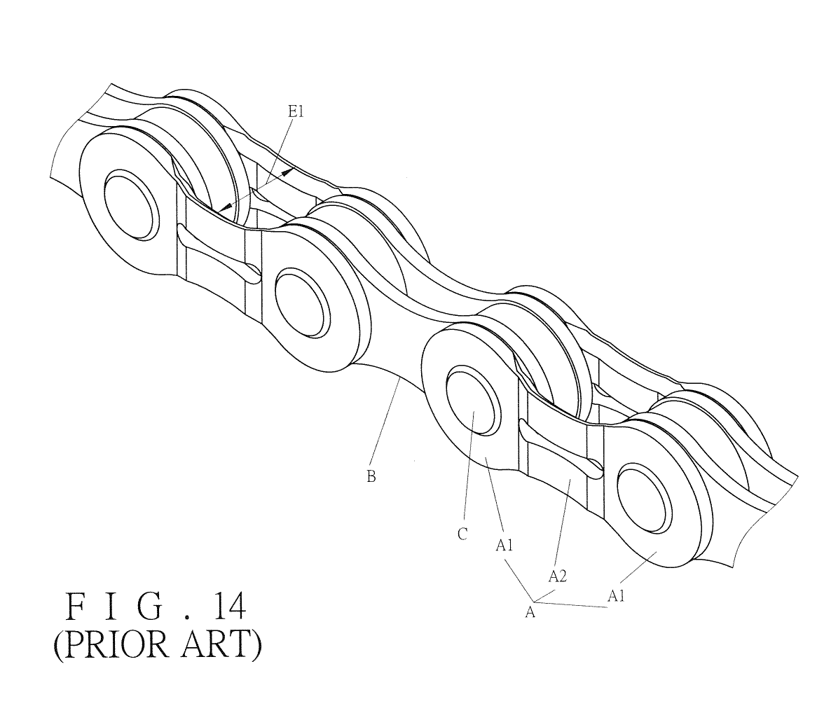

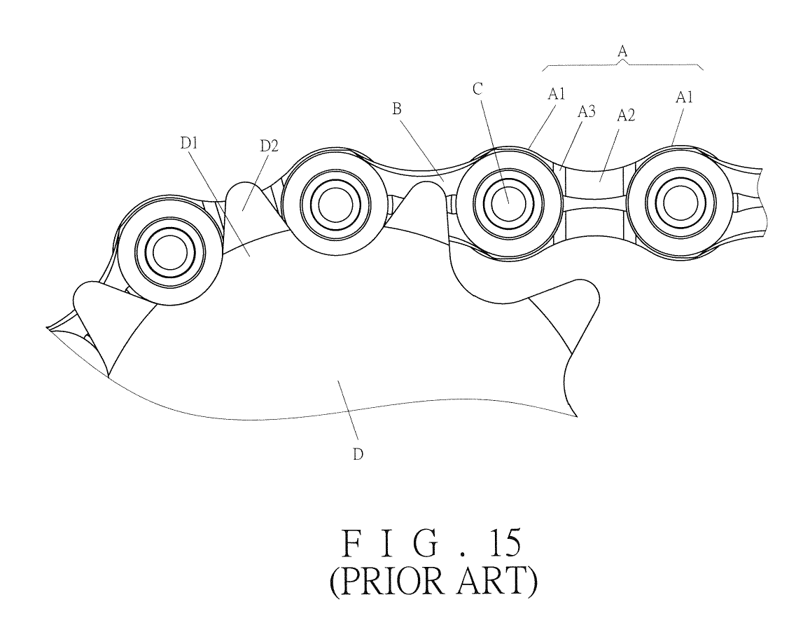

FIG. 11 and FIG. 12 show a first link plate body (2A) and a second link plate body (2B), respectively, in accordance with still another embodiment of the invention. The first link plate body (2A) is configured as an inner link plate, while the second link plate body (2B) is configured as an outer link plate.

As shown in FIG. 11, two ends of the first link plate body (2A) each are configured with an arc-shaped first combining portion (21A), wherein the two first combining portions (21A) are opposite to each other. Moreover, a first middle portion (23A) is configured between the two first combining portions (21A), wherein the first middle portion (23A) is indented by expanding from the inner surface of the first link plate body (2A) towards the outer surface of the first link plate body (2A) and thinned. Thus, in this embodiment, the first middle portion (23A) has a sunken inner surface and is thin relative to other portions of the first link plate body (2A). The junction between the first middle portion (23A) and a corresponding first combining portion (21A) is configured with an arc-shaped first connection surface (24A), wherein a first protrusion (27A) protruding from the first middle portion (23A) is configured between the two first connection surfaces (24A) and has the same height as the two first combining portions (21A).

As shown in FIG. 12, two ends of the second link plate body (2B) each are configured with an arc-shaped second combining portion (21B), wherein the two second combining portions (21B) are opposite to each other. Moreover, a second middle portion (23B) is configured between the two second combining portions (21B), wherein the second middle portion (23B) is indented by expanding from the inner surface of the second link plate body (2B) towards the outer surface of the second link plate body (2B) and thinned. Thus, in this embodiment, the second middle portion (23B) has a sunken inner surface and is thin relative to other portions of the second link plate body (2B). The junction between the second middle portion (23B) and a corresponding second combining portion (21B) is configured with an arc-shaped second connection surface (24B), wherein a second protrusion (27B) protruding from the second middle portion (23B) is configured between the two second connection surfaces (24B) and has the same height as the two second combining portions (21B).

While the invention has been described by way of example and in terms of the preferred embodiments, it is to be understood that the invention is not limited to the disclosed embodiments. Therefore, the scope of the appended claims should be accorded the broadest interpretation so as to encompass all such modifications and similar arrangements.

1. A link plate, comprising a link plate body, wherein two ends of the link plate body each are configured with a combining portion, wherein the two combining portions are opposite to each other and each have an axle hole, wherein a middle portion is configured between the two combining portions, wherein a junction between the middle portion and a corresponding combining portion is configured with an arc-shaped connection surface, and wherein at least one protrusion protruding from the middle portion is configured between the two connection surfaces.

2. The link plate as claimed in claim 1, wherein each said connection surface has an inner edge and an outer edge forming borders with the middle portion and a corresponding one of said combining portions, respectively, and wherein the inner edge and the outer edge of each said connection surface form two arcs.

3. The link plate as claimed in claim 2, wherein the inner and outer edges of each said connection surface are configured as equidistance double arcs.

4. The link plate as claimed in claim 1, wherein each said connection surface further has two guiding surfaces extending therefrom, and wherein the two guiding surfaces of each said connection surface expand at two side edges of the link plate body, respectively.

5. The link plate as claimed in claim 4, wherein two side edges of the middle portion each are configured with an inclined entrance portion, wherein the two entrance portions are opposite to each other and each extend between two of said guiding surfaces.

6. The link plate as claimed in claim 1, wherein the middle portion has a sunken inner surface and a raised outer surface, and wherein the middle portion is thin relative to other portions of the link plate body.

7. The link plate as claimed in claim 1, wherein the middle portion has a sunken inner surface and a flat outer surface, and wherein the middle portion is thin relative to other portions of the link plate body.

8. The link plate as claimed in claim 1, wherein the link plate body is an outer link plate or an inner link plate.

9. The link plate as claimed in claim 1, wherein each said connection surface is an inclined surface or a flat surface.

10. The link plate as claimed in claim 9, wherein each said connection surface inclines from a corresponding one of said combining portions towards the middle portion.
